(19) United States
(12) Patent Application Publication
(10) Pub. No.: US 2013/0232271 A1
(43) Pub. Date: Sep. 5, 2013

(54) METHOD FOR PROVIDING LOGICAL SPACE-BASED POLYMORPHIC SERVICE AND DEVICE USING SAME

(71) Applicant: Hyun Kim, Daejeon (KR)

(72) Inventor: Hyun Kim, Daejeon (KR)

(73) Assignee: ELECTRONICS AND TELECOMMUNICATIONS RESEARCH INSTITUTE, Daejeon (KR)

(21) Appl. No.: 13/883,605

(22) PCT Filed: Nov. 1, 2011
(86) PCT No.: PCT/KR2011/008244

§ 371 Date: May 6, 2013

(30) Foreign Application Priority Data
Nov. 5, 2010 (KR) 10-2010-0110026

(51) Int. Cl. H04L 29/08

(52) U.S. Cl. CPC H04L 29/0845
USPC 709/226

(57) ABSTRACT

Provided are a method of providing a polymorphic service based on a logical space and an apparatus using the method. The method includes receiving, at a polymorphic service server, location information on a polymorphic service client and service request information, which is information on a service requested by the polymorphic service client, and searching for, at the polymorphic service server, dynamic resources available for providing the service on the basis of the location information and the service request information, and providing the service on the basis of the available dynamic resources. Accordingly, a huge space can be implemented as one service providing space in one unified way, and individual services can interoperate as one service to build a standardized large-scale ubiquitous environment.

### TECHNICAL FIELD

The present invention relates to a method of providing a polymorphic service based on a logical space, and more particularly, to a method of providing service by causing a service providing apparatus to interoperate with a service user in one logical space and an apparatus for implementing such a method.

### BACKGROUND ART

Most services provided on the basis of existing networks have a single form in which a current service environment of a service user is not taken into consideration, and are based on a service-oriented architecture (SOA).

FIG. 1 is a conceptual diagram of an existing network service based on an SOA.

Referring to FIG. 1, a service provider 100 registers a service to provide to a service broker 110, and when there is a service request of a service user 120, the service broker 110 connects the service user 120 with the service provider 100.

When a service connection request is received from the service broker 110, the service provider 100 provides the corresponding service to the service user 120 who has requested the service.

With the development of ubiquitous technology in which an environment of a service user is taken into consideration, services based on an existing SOA are evolving into a service model in which a service environment of a user is taken into consideration.

An example of such a model is a virtual personal world (VPW) model for providing a polymorphic service in which an environment of a service user is taken into consideration.

A polymorphic service model is capable of self-reconfiguration according to information on a dynamically varying user and environment, and denotes a service optimized to actively cope with a change in a user environment. A VPW is a virtual environment for providing a polymorphic service, which is implemented to build a user-oriented ubiquitous environment in which a personal space is dynamically configured on the basis of a user's intention and surroundings and provide an appropriate personalized service/environment for current conditions.

In other words, to build an effective ubiquitous environment, technology for causing surrounding network devices and users of the network devices to interoperate with each other in one space and providing a service varying according to a variable service environment is needed.

“Topological World Modeling Using Semantic Space” (Proceedings on Workshop on Location Modeling for Ubiquitous Computing, 2001) has disclosed a method of modeling network devices and users in one space.

In a ubiquitous computing environment, location of services user, services available at a current location of a service user, and information on how the location of the service user varies need to be seriously taken into consideration. Such information can be obtained by using information on what kinds of devices are present in a specific place and dynamically tracking a location of a user.

To obtain location information on a user or device in a space, calculation of a distance, intersecting point, and path can be used. However, space modeling through calculation of an actual distance, intersecting point, and path has high complexity, and thus is hard to implement in practice. Also, dynamic tracking of a location of a user requires a large amount of resources, and thus is hard to implement in practice.

For this reason, simplified space modeling and a location tracking method need to be used to obtain such spatial information.

For example, space modeling can be performed using only a list of rooms included in a building and a list of distinguishable objects present in a hallway connecting such rooms and the respective rooms, and to track dynamic movement of persons, simplified space modeling can be implemented using an authentication system making use of a part of human body when the persons enter a room, or another method.

A semantic space database can be used to reduce complexity of a method of expressing space information.

A semantic space is required to express persons, electronic devices, and software services, and should provide a standardized simple naming system for expressing them. Table 1 below is a table for simplifying and expressing a space in spatialization modeling.

TABLE 1

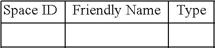

In Table 1, a space identification (ID) can be utilized as a code that can be used in a system, and a friendly name can be utilized as information for the system to cause a specific person to recognize a space. A type can be used to describe a type of a space.

In an actual space, several floors may overlap each other in one building, and a portion may peculiarly project from the building. Thus, when space modeling is performed, there may be portions that overlap and are unclearly expressed in a space.

To solve such a problem of space modeling, a spatial expression in which one space is included in another space can be used. Specifically, when one space is included in another space, overlapping in a space can be expressed using a set symbol.

For example, a proposition that one space S is included in another space T can be expressed as S⊂T and in the form of Table 2 below.

TABLE 2

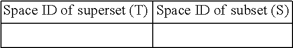

Another consideration in a semantic space expression is what is in a space. In other words, information on what kinds of devices, objects, and persons are included in a space is needed to express a semantic space.

A specific device, object, and person a included in a specific space S can be expressed using a set symbol as a∈S. In reality, a is an expression denoting a location of the specific device, object, and person. A location of a specific object in a specific space can also be expressed using Table 3 below.

TABLE 3

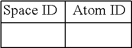

Such a space modeling method utilizing a set and list can be used to simplify a small space, but has a limitation in modeling a large space.

Also, since it is possible to know only actual location information on a physical device and service user, it is difficult to standardize and implement, when a service user requests a specific service in an actually implemented ubiquitous environment, a system for processing information on what the service is and what available devices are.

### DISCLOSURE

### Technical Problem

The present invention is directed to providing a logical space-based polymorphic service that provides a service in which an environment of a service user is taken into consideration by expressing a user and a service device in one logical space.

The present invention is also directed to providing a logical space-based polymorphic service providing apparatus that provides a service in which an environment of a service user is taken into consideration by expressing a user and a service device in one logical space.

### Technical Solution

One aspect of the present invention provides a method of providing a polymorphic service based on a logical space, including: receiving, at a polymorphic service server, location information on a polymorphic service client and service request information, which is information on a service requested by the polymorphic service client; and searching for, at the polymorphic service server, dynamic resources available for providing the service on the basis of the location information and the service request information, and providing the service on the basis of the available dynamic resources. The method may further include obtaining, at the polymorphic service server, resource characteristic information based on the service request information from a service provider. Receiving, at the polymorphic service server, the location information on the polymorphic service client and the service request information, which is the information on the service requested by the polymorphic service client may include: receiving physical space information on the polymorphic service client and converting the physical space information into logical space information; and obtaining a physical device node included in a logical space on the basis of the logical space information, and obtaining detailed logical space information on the polymorphic service client through physical resources included in the physical device node. The physical space information may be at least one of a current location or altitude of the polymorphic service client received through a portable terminal capable of receiving the location information on the polymorphic service client. The logical space information may express a superspace and a subspace included in the superspace in units of four digits using a hexadecimal number of 32 digits. The logical space information may include at least one of a unique identification (ID) of a space, information on logical zones in the space and topological information between the zones in the space, information on a user in the space, and information on a physical device in the space and physical device access. Searching for, at the polymorphic service server, the dynamic resources available for providing the service on the basis of the location information and the service request information, and providing the service on the basis of the available dynamic resources may include: searching for physical resources included in a physical device node available at the location of the polymorphic service client on the basis of the location information; and providing the service requested by the polymorphic service client on the basis of information on the searched physical resources and the resource characteristic information received from the service provider and based on the service request information. The resource characteristic information may be information on at least one of physical resources required to provide the service requested by the polymorphic service client and characteristics of the physical resources.

Another aspect of the present invention provides an apparatus for providing a polymorphic service based on a logical space, including: a common space registerer configured to provide location information for providing the polymorphic service to a polymorphic service client; and a polymorphic service server configured to receive the location information provided by the common space registerer and provide the polymorphic service to the polymorphic service client. The apparatus may further include a service provider configured to provide physical resources required to provide the service requested by the polymorphic service client, characteristics of the physical resources, and the requested service to the polymorphic service server. Location information on the polymorphic service client, a physical device node, and a physical device is registered in the common space registerer, and the common space registerer may express the location information as information on one logical space. The logical space information may express a superspace and a subspace included in the superspace in units of four digits using a hexadecimal number of 32 digits. The logical space information may include at least one of a unique ID of a space, information on logical zones in the space and topological information between the zones in the space, information on a user in the space, and information on the physical device in the space and physical device access. The polymorphic service server may include: a dynamic resource searching unit configured to search for information on physical resources available at a location of the polymorphic service client on the basis of the location information received from the common space registerer; and a user location tracking unit configured to obtain the location information on the polymorphic service client. The user location tracking unit may receive physical space information on the polymorphic service client from a portable terminal of the polymorphic service client. The polymorphic service server may include: a service searching unit configured to search whether or not the service requested by the polymorphic service client is available; a service configuration unit configured to configure the service to provide to the polymorphic service client on the basis of the information received from the service searching unit and the dynamic resource searching unit; and a service interoperation performance unit configured to provide the service to the polymorphic service client on the basis of information received from the service configuration unit.

### Advantageous Effects

Using the above-described method of providing a polymorphic service based on a logical space according to an exemplary embodiment of the present invention and an apparatus using the method, it is possible to express a service user and a service providing apparatus in one logical space and provide an adaptive service according to a current location of the service user.

Consequently, a huge space can be implemented as one service providing space in one unified way, and individual services can interoperate as one service to build a standardized large-scale ubiquitous environment

### DESCRIPTION OF DRAWINGS

FIG. 1 is a conceptual diagram of an existing network service based on a service-oriented architecture (SOA).

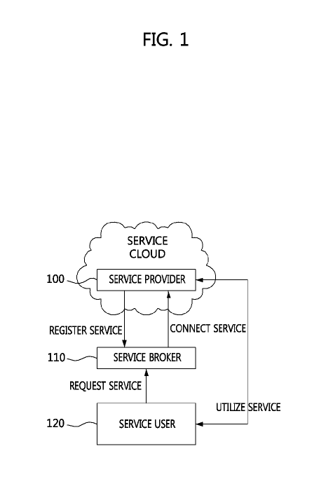

FIG. 2 is a conceptual diagram illustrating a method of providing a polymorphic service based on a logical space according to an exemplary embodiment of the present invention.

FIG. 3 is a flowchart illustrating a method of providing a polymorphic service based on a logical space according to an exemplary embodiment of the present invention.

FIG. 4 is a conceptual diagram of a system implementing a polymorphic service according to another exemplary embodiment of the present invention.

FIG. 5 is a flowchart illustrating a method of providing a polymorphic service based on a logical space according to another exemplary embodiment of the present invention.

FIG. 6 is a conceptual diagram illustrating respective devices and operation of the respective devices for providing a polymorphic service according to an exemplary embodiment of the present invention.

### MODES OF THE INVENTION

While the invention is susceptible to various modifications and alternative forms, specific embodiments thereof are shown by way of example in the drawings and will herein be described in detail. However, it should be understood that there is no intent to limit the invention to the particular forms disclosed, but on the contrary, the invention is to cover all modifications, equivalents, and alternatives falling within the spirit and scope of the invention

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail. Like numbers refer to like elements throughout the description of the drawings, and description of the same element will not be reiterated.

In exemplary embodiments of the present invention below, a physical device node may denote a computing server that manages and controls sensors or devices actually present in a physical environment. For example, a physical device node may be a sensor node bundling a plurality of sensor devices or a home server bundling devices in a house together. Current network environments are individually implemented and are not managed all together. Thus, even if a user is present in a logical space zone consisting of sensors or devices, it is impossible to obtain information on a location of the user. However, in exemplary embodiments of the present invention, when a common space registry managing location information that can be expressed in the same format in one logical space is prepared, and physical device nodes managing individual logical space zones are registered in the common space registry, a service user and service providing apparatus are included in one logical zone, and the service user can be provided with a service in which a service environment is taken into consideration at his/her location through an available service providing apparatus.

Also, in exemplary embodiments of the present invention below, a service provider and a service broker are described as separate parts for convenience, but may be implemented as a single form, one physical apparatus or one module. Further, a service provider and a service broker may be implemented not as physical devices or groups respectively but as a plurality of physical devices or groups.

Location information used in the present invention below may include altitudes of a service user, physical device node, and physical resources included in the physical device node in a vertical plane as well as locations of them in a plane.

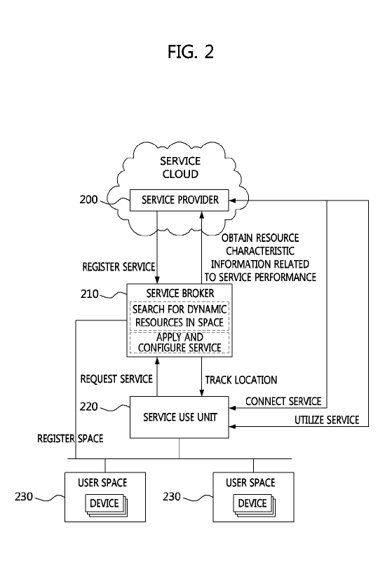

FIG. 2 is a conceptual diagram illustrating a method of providing a polymorphic service based on a logical space according to an exemplary embodiment of the present invention.

The term “polymorphic service” may indicate a service that can be self-reconfigured according to information on a dynamically varying user and environment.

Referring to FIG. 2, a service provider 200, a service broker 210, a service using unit 220, and a physical device node 230 may be included to provide a polymorphic service based on a logical space.

The service provider 200 and the service broker 210 are separately expressed to conveniently describe operation performed to implement the present invention. However, as long as they do not depart from the spirit of the present invention, the service provider 200 and the service broker 210 may be combined into one subject or separately implemented as a plurality of subjects, which also falls within the scope of the present invention.

The service provider 200 indicates a corporation or person who provides a network-based service. The service provider 200 may register a service to provide through the service broker 210, and provide the service broker 210 with resource characteristic information, which is information on physical resources required to provide the service.

In an exemplary embodiment of the present invention, a polymorphic service may be provided in different forms according to an environment of a user using various sensors and devices in a space zone.

For example, when a display device is in a logical space zone of a user, a service providing a user with weather information may display “The weather will be very nice tomorrow.” on the screen. When there is a speaker instead of a display device in the logical space zone of the user, the information may be transferred through a voice saying “The weather will be very nice tomorrow.”

In other words, to implement a polymorphic service, it is necessary to know what kind of resources are needed to implement the service and what characteristics of the resources are (whether to provide an output as visual information or auditory information), and the service broker 210 may obtain the resource characteristic information, which is information on the physical resources for providing the service, from the service provider 200.

The service broker 210 may serve to relay a service between the service provider 200 and the service using unit 220. The service broker 210 may search for dynamic resources, which are available physical resources, to provide the service using unit 220 with the service registered by the service provider 200, apply the service to the service using unit 220, and configure the service.

For example, the service broker 210 may search for dynamic resources (a display device and speaker device) available at a current location of the service using unit 220 on the basis of characteristics of the service requested by the service using unit 220, and cause the corresponding device and the service using unit 220 to interoperate with each other, thereby providing the service to the service using unit 220.

Also, when a service is requested by the service using unit 220, the service broker 210 may track a location of the service using unit 220 to provide the service using unit 220 with the service.

In an exemplary embodiment of the present invention, current location information on a user and a location of a service device present in an actual physical space may be expressed in one logical space.

For example, assuming that the service using unit 220 having a portable terminal moves in a real space, current physical space information on the service using unit 220 may be obtained in a method of obtaining location information, which is physical space information, using a portable terminal

To obtain at least one of current location information and altitude information, which is physical space information on the service using unit 220, a satellite positioning system or a system capable of finding a current location and altitude of the portable terminal, such as a cell positioning system, may be used. As the satellite positioning system for finding a location and altitude of a user of a portable terminal, for example, the global positioning system (GPS), the GLObal NAvigation Satellite System (GLONASS), and Galileo may be used.

As another method of finding a location of the service using unit 220, angle of arrival (AOA) measurement in which at least two base stations measure directions of a signal received from a portable terminal using a mobile communication network to find a location of the terminal, cell-identification (ID) and enhanced cell-ID measurement in which a location of a terminal is estimated using information on a service cell, time difference of arrival (TDOA) measurement in which a TDOA between a service base station signal and a neighboring base station signal is measured, etc. may be used.

In addition, a method in which an assisted global positioning system (AGPS) receiving information from a satellite and a wireless network base station is mixed with TDOA measurement, that is, satellite positioning and wireless network-based positioning are mixed, may be used to obtain location information that is physical space information on a portable terminal.

After the current location and altitude of the portable terminal are found, a current indicating direction of the portable terminal may be additionally found using a sensor included in the portable terminal to provide a service.

The portable terminal may have an acceleration sensor, gyrosensor, gravity sensor, etc. for finding the indicating direction.

The indicating direction of the portable terminal may be found using, for example, the acceleration sensor and gyrosensor of the portable terminal together. When a direction indicated by an antenna of the portable terminal is the direction sensed by the acceleration sensor and gyrosensor, it is possible to know a direction currently indicated by the portable terminal of a service user with respect to the direction of the antenna of the portable terminal and provide the service user with a service on the basis of the indicating direction.

The above-described location information providing method is based on the assumption of a service user who uses a portable terminal. However, a service user who uses a terminal having a function of providing location information other than a portable terminal can provide the service broker 210 with information on a current location, which is his/her physical space information, using a method other than the above-described location information providing method as long as the method does not depart from the spirit of the present invention.

The location information obtained through the portable terminal of the service using unit 220 is physical space information. On the basis of the obtained physical space information, it is possible to know logical space information on a space in which a user is present.

For example, it is assumed that the service using unit 220 is in area A of Daejeon, and there are device nodes, such as computer servers a, b and c, managing and controlling various sensors or devices in area A.

Device node IDs of the device nodes a, b, c, etc., information on GPS coordinates at which the device nodes are present, resource information on the sensors or devices in the device nodes, etc. may be registered in a common space registry that manages logical space information on the service using unit 220, device nodes, and devices managed by the device nodes. The information registered in the common space registry is an exemplary embodiment, and information capable of providing other space information may also be included in the common space registry.

The location information on the service using unit 220 is obtained from the portable terminal of the service using unit 220, and using the common space registry, it is possible to know that device nodes currently connected with the location of the service using unit 220 are the device nodes a, b and c. Using sensors (e.g., a radio frequency identification (RFID) sensor, camera, and active tag) capable of providing user recognition information in the respective nodes, it is possible to obtain a logical zone location, that is, logical space information on a location at which the service using unit 220 is currently present.

When an RFID sensor of the device node a notifies that an event corresponding to a service using unit ID has occurred, it is possible to know that the user is currently in a zone of the device node a.

In exemplary embodiments of the present invention below, device nodes such as the computer servers a, b and c managing and controlling various sensors and devices may be referred to as physical device nodes, and the device nodes a, b and c included in such physical device nodes may be referred to as physical resources.

As a result, it is possible to know that the service using unit 220 is in a logical space of the physical resource a, and using such a method, detailed current logical space information on the service using unit 220 can be obtained. Also, information on what kind of sensors and devices are present in the logical space can be obtained from the common space registry in which information on users and device nodes are stored.

In the exemplary embodiment of the present invention, physical device nodes and physical resources have a single-layer structure, but may be implemented to have a structure of one or more layers.

A physical resource providing recognition information on a location of a user in each physical device node can provide information on the user location in a method other than a sensor-based method as long as the method does not depart from the spirit of the present invention that information on a location of the service using unit 220 is provided, and this is also included in the scope of the present invention.

Specifically, after information on a location of the service using unit 220 is received first, a physical device node present at the location may be searched for on the basis of the location information of the service using unit 220, and then information on a detailed logical space in a logical space of the service using unit 220 may be obtained through a physical device included in the physical device node.

The service using unit 220 may provide the service broker 210 with service request information, which is information on a service to be received, and receive the requested service from the service provider 200 connected through the service broker 210 on the basis of the service request information.

The service using unit 220 may provide the service broker 210 with information on its location using the portable terminal capable of providing the location information.

The physical device node 230 may be a service providing apparatus included in the corresponding logical space in which a service user is present.

To build a ubiquitous environment, the physical device node 230 that controls and manages the sensor or device may be installed in a physical space zone. The installed physical device node 230 and physical device, such as a sensor or device, included in the physical device node 230 may register information on a current location of the physical device node 230 and the physical device included in the physical device node 230 in the service broker 210, and the service broker 210 may provide the service using unit 220 with a service on the basis of the registered location information on the physical device node 230 and the physical device.

In other words, the physical space zone, which is the actual location of the physical device node 230 and the physical device (e.g., a server, sensor, and device), can be expressed and registered in one logical space, and can be registered in the logical space using a standardized method.

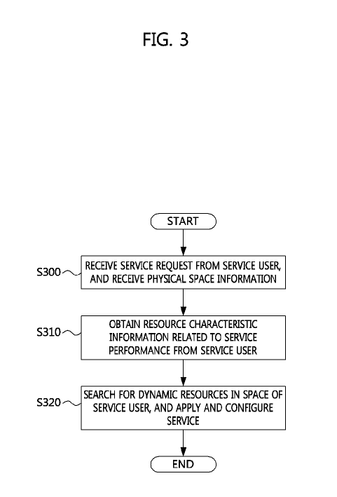

FIG. 3 is a flowchart illustrating a method of providing a polymorphic service based on a logical space according to an exemplary embodiment of the present invention.

Referring to FIG. 3, a service broker receives a service request from service using unit, and the service broker may receive physical space information, that is, information on a space in which a service user is present, from a device such as a portable terminal (S300).

The service using unit may provide the service broker with service request information, that is, information on the service that the service using unit wants to receive. The service user provides the service broker with physical space information, that is, information on a space in which he/she is present, using a device such as a portable terminal, and the service broker searches for a physical device node included in the current location of the service user and physical devices included in the physical device node and may obtain detailed current logical space information on the service user.

The service broker may obtain resource characteristic information related to service performance from a service provider (S310).

In an exemplary embodiment of the present invention, a polymorphic service is implemented differently according to an environment of the service using unit, and thus the service broker needs to receive resource characteristic information related to service performance, such as what kind of dynamic resources are needed to provide the requested service and what characteristics of the dynamic resources are, from the service provider.

The service broker may search for dynamic resources in a current space of the service using unit, and apply and configure the service (S320).

The dynamic resources may be physical resources available for providing the service to the service using unit. Searching for the dynamic resources in the space zone may involve searching for a device available in the space in which the using unit is present, and dynamically configuring the service to be provided to the service using unit on the basis of the search results.

For example, when a display device is available in the space in which the using unit is present, and a service providing a specific image is requested by the using unit, the service provided by the service provider may be dynamically implemented by the display device.

To implement a polymorphic service based on a logical space according to an exemplary embodiment of the present invention, information on a physical space, which is a current location of a service using unit, services available in the current physical space of the service using unit, and information on how the location of the service using unit varies may be seriously taken into consideration. Such physical space information can be obtained using information on what kinds of devices are present in a specific place and by dynamically tracking a location of a user.

To obtain physical space information on a using unit or device in a space, calculation of a distance, intersecting point, and path can be used. However, space modeling through calculation of an actual distance, intersecting point, and path has high complexity, and thus is hard to implement in practice. Also, dynamic tracking of a location of a using unit requires a large amount of resources, and thus is hard to implement in practice.

For this reason, simplified space modeling and location tracking methods need to be used to obtain such spatial information.

Table 4 below illustrates a method of expressing physical space information on a service using unit and a device, which is a physical resource, as logical space information according to an exemplary embodiment of the present invention.

TABLE 4

```
  <space id=“unique ID” >
  <zones>IDs of zones in space and information on relation
  between zone IDs
</zones>
  <users>user ID and information on time to enter zone </users>
  <devices>ID of device in zone and information related to device
  access
</devices>
  </space>
```

Referring to Table 4, space information may include a space ID (<space id=“unique ID”>), information on logical zones in a space and topological information between the zones (<zones> IDs of zones in space and information on relation between zone IDs </zones>), information on a user in a space (<users> user ID and information on time to enter zone </users>), information on a physical device in the space and physical device access (<devices> ID of device in zone and information related to device access </devices>), and so on.

A space ID denotes an expression scheme whereby a specific space can be defined and expressed, and information on logical zones in a space and topological information between the zones denote definitions and expressions of the zones included in the space and relation between the zones.

A user ID and information on a time to enter a zone specify a current user present in a space and denote information on a time when the user enters the zone, and information on a physical device in a space and physical device access may be information on a physical device included in a space and information generated with regard to access to the physical device.

Such expression methods shown in Table 4 are one exemplary embodiment of the present invention. A space, user, and device in the space may be expressed using different fields than the above-described methods, and may also be expressed in a standardized format so as to be applied to various devices.

Among the pieces of information, space information (<space id=“unique ID”> may be expressed to have one unique ID per space as shown in Table 5 below according to a system similar to Internet protocol version 6 (IPv6).

TABLE 5

| | | | | | | | |
|---|---|---|---|---|---|---|---|
| 2001 | 0db8 | 85a3 | 08d3 | 1319 | 8a2e | 0370 | 7334 |

| | | | | |
|---|---|---|---|---|
| Country | State | City | Space | Zone |

Since an expression of Table 5 above can provide one ID per 10 m² of the entire space of the earth, the unique space ID of a physical space can be managed using such a system. A hexadecimal number of 32 digits may express a country, state, city, space and zone (zone indicates a zone managed by a physical device node).

In other words, using a hexadecimal number of 32 digits, it is possible to express a superspace and subspaces included in the superspace in units of four digits.

Since a plurality of physical device nodes may be present in a space, it is possible to express a huge logical space that is practically infinite using an expression as shown in Table 5.

The above-described logical space information expression method is one exemplary embodiment of the present invention. A location of a using unit can be expressed using a method other than the above-described method as long as the other method does not depart from the spirit of the present invention. For example, each digit and a type of numerical notation for expressing logical location information may be changed, and location information can be expressed using inclusion relations, such as a set relation, or relations between subordinates and superiors, such as a tree structure.

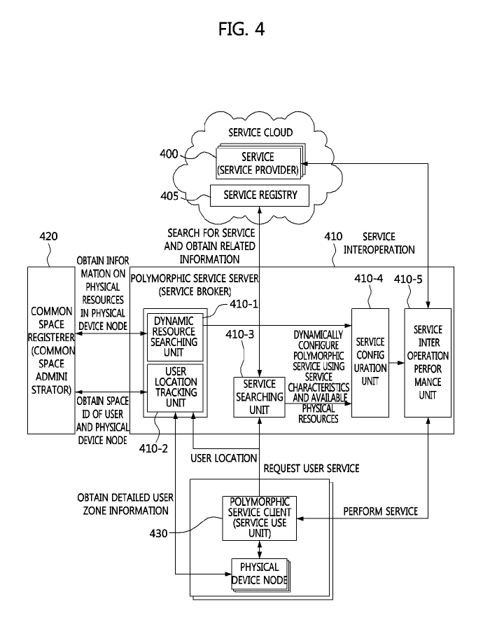

FIG. 4 is a conceptual diagram of a system implementing a polymorphic service according to another exemplary embodiment of the present invention.

Referring to FIG. 4, a system implementing a polymorphic service is based on a distributed system having a client/server structure, and may include a service provider 400, a polymorphic service server 410, a common space registerer 420, and a polymorphic service client 430.

The polymorphic service server 410, the common space registerer 420, and the service provider 400 are separately expressed to conveniently describe functions. As long as they do not depart from the spirit of the present invention, these respective parts may be combined into one subject or separately implemented as a plurality of subjects, which also falls within the scope of the present invention.

The polymorphic service client 430 is a client of a polymorphic service that receives the polymorphic service, and may provide service request information, which is information required to request a service to be received, through a service searching unit 410-3 included in the polymorphic service server 410. Also, the polymorphic service client 430 may provide a user location tracking unit 410-2 included in the polymorphic service server 410 with physical space information, which is information on a current user location.

Using a portable terminal, the polymorphic service client 430 provides the physical space information, which is current location information on the polymorphic service client 430, to the user location tracking unit 410-2 included in the polymorphic service server 410, and the user location tracking unit 410-2 may obtain a physical device node present at the current location of a user through the common space registerer 420.

The polymorphic service server 410 may include a dynamic resource searching unit 410-1, the user location tracking unit 410-2, the service searching unit 410-3, a service configuration unit 410-4, and a service interoperation performance unit 410-5.

The dynamic resource searching unit 410-1, the user location tracking unit 410-2, the service searching unit 410-3, the service configuration unit 410-4, and the service interoperation performance unit 410-5 included in the polymorphic service server 410 are an exemplary embodiment for facilitating description. Functions performed by the respective modules may be combined and implemented as one module, or functions performed by one module may be separated and become a plurality of modules.

The dynamic resource searching unit 410-1 may receive information on what kind of available devices are in a space zone of the polymorphic service client 430 from the common space registerer 420. In other words, the dynamic resource searching unit 410-1 may obtain information on physical resources in the physical device node from the common space registerer 420.

The user location tracking unit 410-2 may obtain a space ID of the user and physical device node information on the basis of the physical space information received from the polymorphic service client 430, and information on a detailed logical space in which the user is present from a physical resource, such as a sensor device, included in the physical device node.

The service searching unit 410-3 may search a service registry 405 for whether or not the service requested by the polymorphic service client 430 is available, thereby obtaining the related information.

The service configuration unit 410-4 may dynamically configure polymorphic service using service characteristics and an available physical resource. The service configuration unit 410-4 may receive information on characteristics of the service (characteristics of a resource required to perform the service) from the service searching unit 410-3, obtain the information on which device is available in the user space zone from the dynamic resource searching unit 410-1, and then newly configure an existing service on the basis of the obtained information.

The service interoperation performance unit 410-5 may interoperate with the service provider 400 to perform the actual service provided by the service provider 400 according to a service performance mechanism obtained from the service configuration unit 410-4.

The common space registerer 420 may provide the dynamic resource searching unit 410-1 with the information on physical resources in the physical device node, and also provide the user location tracking unit 410-2 with the space ID of the user and the information related to the physical device node.

The common space registerer 420 may register and express the polymorphic service client 430, the physical device node, and the devices included in the physical device node in one logical space, and receive the physical space information from the polymorphic service client 430 to convert the received information into logical space information.

The service provider 400 may register the service to provide in the service registry 405, and provide the service requested by the polymorphic service client 430 through the service interoperation performance unit 410-5.

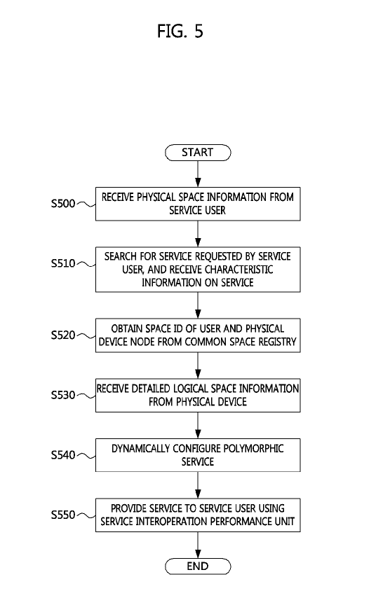

FIG. 5 is a flowchart illustrating a method of providing a polymorphic service based on a logical space according to another exemplary embodiment of the present invention.

Referring to FIG. 5, a polymorphic service server may receive physical space information, which is location information on a polymorphic service client, from the polymorphic service client (S500).

The physical space information that is the information on a current location of the polymorphic service client may be provided to a user location tracking unit that is included in the server providing a polymorphic service and tracks a location of a user.

The physical space information on the polymorphic service client and a service request may be simultaneously provided, but the physical space information on the polymorphic service client may be provided to the polymorphic service server continuously or periodically.

The polymorphic service server accesses a service registry through a service searching unit to search for a service requested by the polymorphic service client and receive characteristic information on the service (S510).

In an exemplary embodiment of the present invention, a polymorphic service is provided using a dynamic resource, which is a physical resource included in a physical device node available in a current environment of a user, the polymorphic service server can obtain the resource characteristic information, which is the characteristic information on the service indicating through which device the service requested by the user can be provided at a current location of the service user, through the service registry in which a service provider has registered a service to provide the service.

The polymorphic service client may obtain a space ID of the user and a physical device node from a common space registerer using a dynamic resource searching unit and the user location tracking unit included in the polymorphic service server, and obtain information on physical resources included in the physical device node (S520).

The location information on the polymorphic service client, the physical device node, and information on the physical device node may be registered in the common space registerer so that the location information on the polymorphic service client, the physical device node, and the information on the physical resources included in the physical device node can be expressed as information on one logical space. Then, the common space registerer may provide the registered information to the polymorphic service server.

The user location tracking unit may obtain the space ID of the user and information on the physical device node included in the space ID from the common space registerer using the information received from the polymorphic service client.

The dynamic resource searching unit may receive the information on the physical resources included in the physical device node from the common space registerer on the basis of the location information on the polymorphic service client.

Detailed logical space information, which is information on a detailed zone of the polymorphic service client, may be received from the physical devices included in the physical device node (S530).

For example, a plurality of physical devices may be included in one physical device node, and the information on the detailed zone of the polymorphic service client can be obtained using sensors included in the physical devices.

The polymorphic service may be dynamically configured using the service characteristics and the dynamic resources, which are available physical resources, received from the dynamic resource searching unit and the service searching unit (S540).

The dynamic resource searching unit receives the information on the physical resources included in the physical device node from the common space registerer, and provides the information to a service configuration unit. The service searching unit receives the information on the service characteristics from the service registry and transfers the information to the service configuration unit. The service configuration unit obtains the information on the dynamic resources available in the space zone in which the polymorphic service client is currently present on the basis of the received information, and may newly configure the service to be provided to the polymorphic service client. In other words, in a polymorphic service, a logically described device can interoperate with a physical device included in an actual space.

The service configured by the service configuration unit and provided by the service provider may be provided to the polymorphic service client (S550).

The service provider may provide the service requested by the polymorphic service client to the service interoperation performance unit included in the polymorphic service server, and the service interoperation performance unit may provide the requested service to the polymorphic service client.

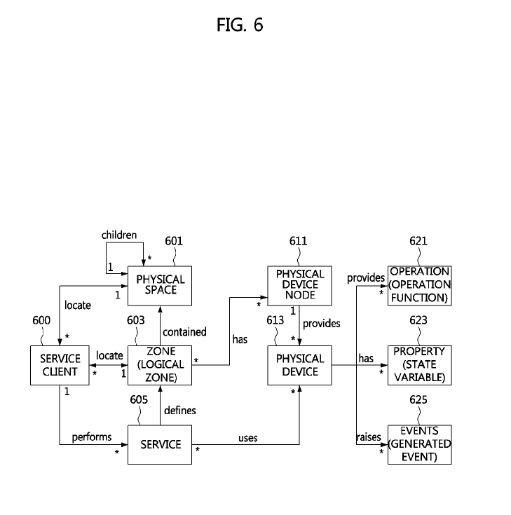

FIG. 6 is a conceptual diagram illustrating respective devices and operation of the respective devices for providing a polymorphic service according to an exemplary embodiment of the present invention.

Referring to FIG. 6, a service client 600 is included in one physical space 601 and one logical zone 603, and may perform a variety of services.

The logical space 603 may include the physical space 601, and the physical space 601 may be hierarchically configured to include a subordinate physical space, which may have a plurality of logical zones.

In the one logical zone 603, several types of services may be performed, and several physical device nodes 611 may be included in the one logical zone 603.

One physical device node 611 may include a plurality of physical devices 613. One physical device 613 provides several operation functions 621 for operating, and may have several state variables 623 indicating a state. Also, when the physical device is a sensor, the physical device may generate a plurality of events 625.

While the invention has been shown and described with reference to certain exemplary embodiments thereof, it will be understood by those skilled in the art that various changes in form and details may be made therein without departing from the spirit and scope of the invention as defined by the appended claims.

1. A method of providing a polymorphic service based on a logical space, comprising:
receiving, at a polymorphic service server, location information on a polymorphic service client and service request information, which is information on a service requested by the polymorphic service client; and
searching for, at the polymorphic service server, dynamic resources available for providing the service on the basis of the location information and the service request information, and providing the service on the basis of the available dynamic resources.

2. The method of claim 1, further comprising obtaining, at the polymorphic service server, resource characteristic information based on the service request information from a service provider.

3. The method of claim 1, wherein receiving, at the polymorphic service server, the location information on the polymorphic service client and the service request information, which is the information on the service requested by the polymorphic service client includes:
receiving physical space information on the polymorphic service client and converting the physical space information into logical space information; and
obtaining a physical device node included in a logical space on the basis of the logical space information, and obtaining detailed logical space information on the polymorphic service client through physical resources included in the physical device node.

4. The method of claim 3, wherein the physical space information is at least one of a current location and altitude of the polymorphic service client received through a portable terminal capable of receiving the location information on the polymorphic service client.

5. The method of claim 3, wherein the logical space information expresses a superspace and a subspace included in the superspace in units of four digits using a hexadecimal number of 32 digits.

6. The method of claim 3, wherein the logical space information includes at least one of a unique identification (ID) of a space, information on logical zones in the space and topological information between the zones in the space, information on a user in the space, and information on a physical device in the space and physical device access.

7. The method of claim 1, wherein searching for, at the polymorphic service server, the dynamic resources available for providing the service on the basis of the location information and the service request information, and providing the service on the basis of the available dynamic resources includes:
searching for physical resources included in a physical device node available at the location of the polymorphic service client on the basis of the location information; and
providing the service requested by the polymorphic service client on the basis of information on the searched physical resources and the resource characteristic information received from the service provider and based on the service request information.

8. The method of claim 7, wherein the resource characteristic information is information on at least one of physical resources required to provide the service requested by the polymorphic service client and characteristics of the physical resources.

9. A polymorphic service apparatus based on a logical space, comprising:
a common space registerer configured to provide location information for providing a polymorphic service to a polymorphic service client; and
a polymorphic service server configured to receive the location information provided by the common space registerer and provide the polymorphic service to the polymorphic service client.

10. The polymorphic service apparatus of claim 9, further comprising a service provider configured to provide the polymorphic service server with physical resources required to provide the service requested by the polymorphic service client, characteristics of the physical resources, and the requested service.

11. The polymorphic service apparatus of claim 9, wherein location information on the polymorphic service client, a physical device node, and a physical device is registered in the common space registerer, and
the common space registerer expresses the location information as information on one logical space.

12. The polymorphic service apparatus of claim 11, wherein the logical space information expresses a superspace and a subspace included in the superspace in units of four digits using a hexadecimal number of 32 digits.

13. The polymorphic service apparatus of claim 11, wherein the logical space information includes at least one of a unique identification (ID) of a space, information on logical zones in the space and topological information between the zones in the space, information on a user in the space, and information on the physical device in the space and physical device access.

14. The polymorphic service apparatus of claim 9, wherein the polymorphic service server includes:
a dynamic resource searching unit configured to search for information on physical resources available at a location of the polymorphic service client on the basis of the location information received from the common space registerer; and
a user location tracking unit configured to obtain the location information on the polymorphic service client.

15. The polymorphic service apparatus of claim 14, wherein the user location tracking unit receives physical space information on the polymorphic service client from a portable terminal of the polymorphic service client.

16. The polymorphic service apparatus of claim 9, wherein the polymorphic service server includes:
a service searching unit configured to search whether or not the service requested by the polymorphic service client is available;
a service configuration unit configured to configure the service to provide to the polymorphic service client on the basis of the information received from the service searching unit and the dynamic resource searching unit; and
a service interoperation performance unit configured to provide the service to the polymorphic service client on the basis of information received from the service configuration unit.
